(19) United States
(12) Patent Application Publication
(10) Pub. No.: US 2025/0140452 A1
(43) Pub. Date: May 1, 2025

(54) OVER-CURRENT PROTECTION DEVICE

(71) Applicant: Polytronics Technology Corp., HSINCHU (TW)

(72) Inventors: YUNG-HSIEN CHANG, Douliu City (TW); CHINGTING CHIU, Taoyuan City (TW); Chia-Yuan Lee, Hsinchu City (TW); CHENG-YU TUNG, Tainan City (TW); CHEN-NAN LIU, Changhua County (TW); HSIU-CHE YEN, Taoyuan City (TW); Yao-Te Chang, Yunlin County (TW); FU-HUA CHU, TAIPEI CITY (TW)

(21) Appl. No.: 18/635,843

(22) Filed: Apr. 15, 2024

(30) Foreign Application Priority Data
Oct. 27, 2023 (TW) 112141231

(51) Int. Cl. H01C 7/13; H01C 7/02; H01C 17/065

(52) U.S. Cl. CPC H01C 7/13; H01C 7/021; H01C 17/06586

(57) ABSTRACT

An over-current protection device includes an electrode layer and a heat-sensitive layer. The heat-sensitive layer includes a polymer matrix and a conductive filler. The polymer matrix includes a polyolefin-based polymer and an olefin-acrylate copolymer. The polyolefin-based polymer is represented by a formula (I):

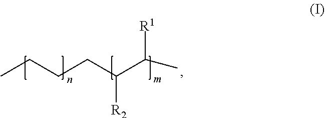

wherein R¹ and R₂ are selected from the group consisting of CH₃, C₂H₅, and C₃H₇. The olefin-acrylate copolymer is represented by a formula (II):

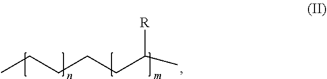

wherein R is selected from the group consisting of COOCH₃, COOC₂H₅, and COOC₄H₉.

### BACKGROUND OF THE INVENTION

### (1) Field of the Invention

The present application relates to an over-current protection device, and more specifically, to an over-current protection device for low-temperature overheating protection.

### (2) Description of the Related Art

Because the electrical resistance of conductive composite materials having a positive temperature coefficient (PTC) characteristic is very sensitive to temperature variation, they can be used as the materials for current sensing devices and have been widely applied to over-current protection devices or circuit devices. More specifically, the electrical resistance of the PTC conductive composite material remains extremely low at normal temperatures, so that the circuit or battery cell can operate normally. However, when an over-current or an over-temperature situation occurs in the circuit or cell, the electrical resistance will instantaneously increase to a high electrical resistance state (e.g., at least above 10⁴Ω), which is the so-called “trip”. Therefore, the over-current will be eliminated so as to protect the cell or the circuit device.

The basic structure of an over-current protection device consists of a PTC material layer with two electrodes bonded to two opposite sides of the PTC material layer. The PTC material layer includes a matrix and a conductive filler. The matrix consists of at least one polymer, and the conductive filler is uniformly dispersed in the matrix and is used as an electrically conductive path. As described above, the positive temperature coefficient characteristic of the over-current protection device comes from the PTC material layer, and therefore its protection temperature can be adjusted by modifying the PTC material layer. Conventionally, high density polyethylene (HDPE) is generally selected as the major constituent in the matrix in order to meet the requirement of overheating protection at lower temperatures. This allows the over-current protection device to cut off the current flow at about 120° C., thereby preventing overheating in a protected electronic apparatus caused by such current flow. However, in certain fields, the electronic apparatuses require a protection temperature significantly lower than the 120° C. previously mentioned, such as game controllers in the video game industry. For example, a game controller may require the protection temperature below 85° C. If the over-current protection device does not operate (i.e., perform its protection function) until the temperature reaches 120° C., the electrical circuit within the game controller may be compromised or even burnt out. Additionally, although the protection temperature of a conventional over-current protection device may be modified to be lower than 85° C., issues such as high electrical resistivity or resistance instability often arise.

Accordingly, there is a need to develop a new type of over-current protection device for low-temperature overheating protection.

### SUMMARY OF THE INVENTION

The present invention provides an over-current protection device, which has a heat-sensitive layer exhibiting a positive temperature coefficient (PTC) characteristic. The heat-sensitive layer includes a polymer matrix and a conductive filler. In order to achieve a lower protection temperature, the present invention incorporates a polyolefin-based polymer and an olefin-acrylate copolymer into the polymer matrix. The side chains (from acrylate repeating unit) in the olefin-acrylate copolymer may create disturbance between molecules of the polymer matrix, thereby lowering the protection temperature of the over-current protection device.

In accordance with an aspect of the present invention, an over-current protection device includes an electrode layer and a heat-sensitive layer. The electrode layer has a top metal layer and a bottom metal layer. The heat-sensitive layer contacts the top metal layer and the bottom metal layer, and is laminated therebetween. The heat-sensitive layer exhibits a positive temperature coefficient (PTC) characteristic and includes a polymer matrix and a conductive filler. The polymer matrix includes a polyolefin-based polymer and an olefin-acrylate copolymer. The total volume of the heat-sensitive layer is calculated as 100%, and the olefin-acrylate copolymer accounts for less than 12%. The polyolefin-based polymer is represented by a formula (I):

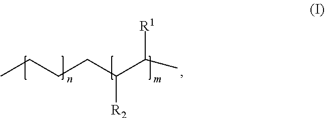

wherein R₁ and R₂ are selected from the group consisting of CH₃, C₂H₅, and C₃H₇, m ranges from 3000 to 8000, and n ranges from 1000 to 3000. The olefin-acrylate copolymer represented is by a formula (II):

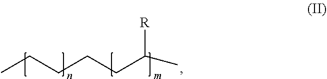

wherein R is selected from the group consisting of COOCH₃, COOC₂H₅, and COOC₄H₉, m ranges from 800 to 5000, and n ranges from 500 to 1000. The conductive filler is dispersed in the polymer matrix, thereby forming an electrically conductive path in the heat-sensitive layer.

In an embodiment, the total volume of the heat-sensitive layer is calculated as 100%, the polyolefin-based polymer accounts for 43% to 56%.

In an embodiment, the total volume of the heat-sensitive layer is calculated as 100%, the polyolefin-based polymer accounts for 45% to 48% and the olefin-acrylate copolymer accounts for 7% to 12%.

In an embodiment, the olefin-acrylate copolymer has an acrylate repeating unit represented by a formula (III):

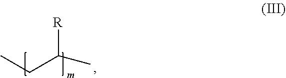

wherein the total weight of the polymer matrix is calculated as 100%, and the acrylate repeating unit accounts for less than 20%.

In an embodiment, the total weight of the polymer matrix is calculated as 100%, and the acrylate repeating unit accounts for 15% to 20%.

In an embodiment, a thermal cutting-off temperature of the over-current protection device ranges from 40° C. to 81° C.

In an embodiment, a hold-current thermal derating ratio of the over-current protection device is less than 0.55, wherein the hold-current thermal derating ratio is defined as a ratio obtained by dividing a hold current of the over-current protection device under 60° C. by a hold current of the over-current protection device under 23° C.

In an embodiment, a first fluctuation value of the over-current protection device under high-resistance state ranges from 0.1 to 2.2. After a thermal treatment from 40° C. to 160° C. for one cycle, a first temperature point indicating high electrical resistance in the over-current protection device is obtained; after the thermal treatment from 40° C. to 160° C. for five cycles, a second temperature point indicating high electrical resistance in the over-current protection device is obtained; and the first fluctuation value is obtained by subtracting the second temperature point from the first temperature point.

In an embodiment, the first fluctuation value ranges from 0.1 to 1.

In an embodiment, a second fluctuation value of the over-current protection device under high-resistance state ranges from 2 to 6.3. After a thermal treatment from 40° C. to 160° C. for one cycle, a first temperature point indicating high electrical resistance in the over-current protection device is obtained; after the thermal treatment from 40° C. to 160° C. for ten cycles, a third temperature point indicating high electrical resistance in the over-current protection device is obtained; and the second fluctuation value is obtained by subtracting the third temperature point from the first temperature point.

In an embodiment, the second fluctuation value ranges from 2 to 3.

In an embodiment, an electrical resistivity of the over-current protection device ranges from 0.01 Ω·cm to 0.065 Ω·cm.

### BRIEF DESCRIPTION OF THE DRAWINGS

The present application will be described according to the appended drawings in which:

FIG. 1 shows a cross-sectional view of an over-current protection device in accordance with an embodiment of the present invention;

FIG. 2 shows the top view of the over-current protection device shown in FIG. 1; and

FIG. 3 shows the resulting curves from the resistance-temperature test (R-T test) for the over-current protection device.

### DETAILED DESCRIPTION OF THE INVENTION

The making and using of the presently preferred illustrative embodiments are discussed in detail below. It should be appreciated, however, that the present application provides many applicable inventive concepts that can be embodied in a wide variety of specific contexts. The specific illustrative embodiments discussed are merely illustrative of specific ways to make and use the invention, and do not limit the scope of the invention.

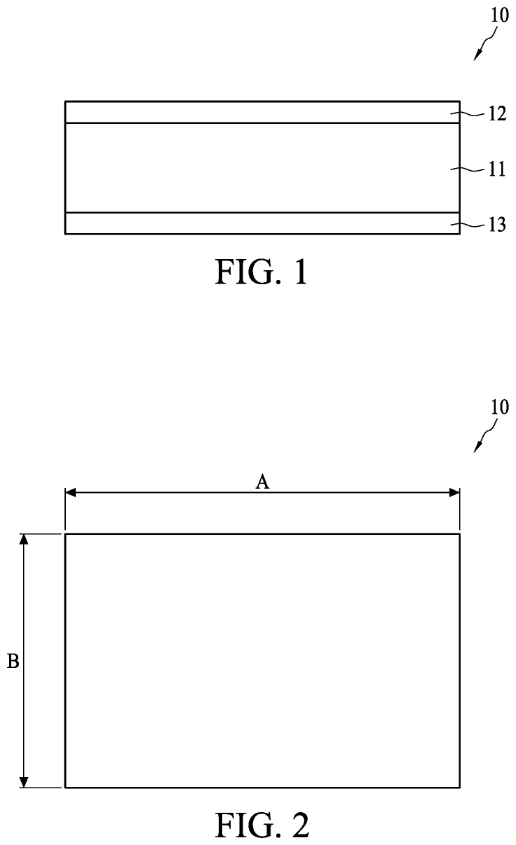

Please refer to FIG. 1. FIG. 1 shows one basic aspect of an over-current protection device 10 of the present invention in cross-sectional view. The over-current protection device 10 includes a heat-sensitive layer 11 and an electrode layer. The heat-sensitive layer 11 has a top surface and a bottom surface, and the electrode layer has a top metal layer 12 and a bottom metal layer 13 attached to the top surface and the bottom surface, respectively. Therefore, the heat-sensitive layer 11 physically contacts the top metal layer 12 and the bottom metal layer 13, and is laminated therebetween. In an embodiment, the top metal layer 12 and the bottom metal layer 13 may be composed of the nickel-plated copper foils or other conductive metals. In addition, the heat-sensitive layer 11 includes a polymer matrix and a conductive filler. The polymer matrix is an electrical insulator sensitive to heat, and the conductive filler is a conductor, by which the heat-sensitive layer 11 exhibits PTC characteristic. The over-current protection device 10 does not operate under normal condition, and therefore the conductive filler is uniformly dispersed in the polymer matrix, and particles of the conductive filler connect to each other in series, thereby forming an electrically conductive path; however, the polymer matrix rapidly expands when the over-current protection device 10 is subject to high temperature, and the particles of the conductive filler are pulled away from each other, thereby cutting off the electrically conductive path in the heat-sensitive layer 11.

In the present invention, in order to effectively lower the protection temperature (i.e., thermal cutting-off temperature, described in detail in the subsequent context), the polymer matrix includes a polyolefin-based polymer and an olefin-acrylate copolymer. The total volume of the heat-sensitive layer 11 is calculated as 100%, the polyolefin-based polymer accounts for 43% to 56% and the olefin-acrylate copolymer accounts for less than 12%. More specifically, the polyolefin-based polymer is represented by a formula (I):

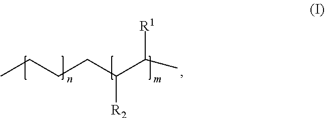

wherein R₁ and R₂ are selected from the group consisting of CH₃, C₂H₅, and C₃H₇, “m” ranges from 3000 to 8000, and “n” ranges from 1000 to 3000; and the olefin-acrylate copolymer is represented by a formula (II):

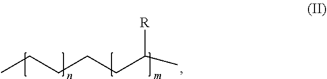

wherein R is selected from the group consisting of COOCH₃, COOCH₅, and COOCH₉, “m” ranges from 800 to 5000, and “n” ranges from 500 to 1000. In the following test, the “m” in the formula (I) is 7300, and the “n” in the formula (I) is 2500; and the “m” in the formula (II) is 3000, and the “n” in the formula (II) is 740. The polyolefin-based polymer may be low density polyethylene (LDPE). Compared with HDPE, the required trip temperature for LDPE is lower. This means that LDPE can be tripped at a temperature below 85° C. to make its electrical resistance correspondingly increase to a high electrical resistance state, thereby cutting off the current flow. In the aforementioned formula (I), R₁ may be the same as or different from R₂. For example, in an embodiment, R₁ and R₂ in the formula (I) are both C₃H₇. In another embodiment, in the formula (I), R₁ is CH₃, and R₂ is C₃H₇. The addition of the olefin-acrylate copolymer to the polymer matrix is motivated by its side chains. The abundance of side chains can lower the trip temperature of the polymer matrix, enabling the over-current protection device 10 to achieve a significantly lower protection temperature. The side chains of the olefin-acrylate copolymer mainly come from its acrylate repeating unit (i.e., the repeating unit indicated by “m” in the formula (II)), which can be represented by a formula (III):

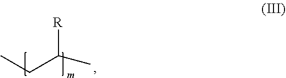

If R is COOCH₃, the acrylate repeating unit is methyl acrylate repeating unit, and the olefin-acrylate copolymer is ethylene-methyl acrylate copolymer (EMA). If R is COOC₂H₅, the acrylate repeating unit is ethyl acrylate repeating unit, and the olefin-acrylate copolymer is ethylene-ethyl acrylate copolymer (EEA). If R is COOCH₉, the acrylate repeating unit is butyl acrylate repeating unit, and the olefin-acrylate copolymer is ethylene-butyl acrylate copolymer (EBA). In the present invention, the olefin-acrylate copolymer and the polyolefin-based polymer together form the structure of interpenetrating polymer network (IPN), constituting the major constituent of the polymer matrix. Owing to the acrylate repeating unit, polymer chains within the polymer matrix can be less ordered, making it less easy to form an orderly arranged region (i.e., crystalline region). In other words, the technical effect of the acrylate repeating unit is to disrupt the crystallization of the polymer matrix, thereby lowering its melting point. This, in turn, lowers the protection temperature of the over-current protection device 10. It is noted that the amount of the acrylate repeating unit should be carefully controlled, as an excessive amount of acrylate repeating unit can lead to an extremely low protection temperature. For example, if the protection temperature of the over-current protection device 10 is lower than the operating temperature of the electronic apparatus to be protected, the current flow may be cut off during normal operation of the electronic apparatus, causing its malfunction. Therefore, the total weight of the polymer matrix is calculated as 100%, and the acrylate repeating unit accounts for less than 20%.

In the present invention, the protection temperature may be referred to as the “thermal cutting-off temperature.” The thermal cutting-off temperature generally corresponds to the temperature point at which the current flow is cut off by the over-current protection device 10. More specifically, the thermal cutting-off temperature of the over-current protection device 10 ranges from 40° C. to 81° C., such as 40° C., 41° C., 42° C., 46° C., 47° C., 48° C., 49° C., 50° C., 51° C., 54° C., 55° C., 56° C., 60° C., 61° C., 62° C., 63° C., 64° C., 65° C., 74° C., 75° C., 76° C., 79° C., 80° C., or 81° C. The thermal cutting-off temperature of the over-current protection device 10 is significantly lower than 120° C., thus making it applicable to any electronic apparatus that requires lower protection temperature, such as a game controller in the video game industry. In order to prevent the over-current protection device 10 from compromising the normal operation of the electrical circuit within the game controller, the thermal cutting-off temperature may be adjusted to be above 50° C. In an embodiment, the thermal cutting-off temperature of the over-current protection device 10 ranges from 50° C. to 60° C. It is noted that the over-current protection device 10, also known as a resettable fuse, can return to a low electrical resistance state when it is cooled down after operation (i.e., tripping). That is, the over-current protection device 10 is a fuse which can be reused a lot of times (i.e., perform its protection function a large number of times) without replacement. Therefore, whether the over-current protection device 10 can maintain the same resistance state after multiple uses is also a consideration. In the present invention, the stability of high electrical resistance state of the over-current protection device 10 is assessed through a resistance-temperature test. In the resistance-temperature test, the over-current protection device 10 is placed in a heating apparatus. The heating apparatus continuously increases the temperature from 40° C. to 160° C., a process referred to as thermal treatment, during which a specific temperature (e.g., a first temperature point, a second temperature point, or a third temperature point) at which the device's electrical resistance rises to 10⁵Ω can be recorded. It should be noted that one cycle of thermal treatment involves increasing the temperature from 40° C. to 160° C. and then decreasing it back to 40° C. This process can be repeated, allowing for multiple cycles of the thermal treatment. After the thermal treatment from 40° C. to 160° C. for one cycle, the first temperature point indicating high electrical resistance in the over-current protection device 10 is recorded; after the thermal treatment from 40° C. to 160° C. for five cycles, the second temperature point indicating high electrical resistance in the over-current protection device 10 is recorded; and after the thermal treatment from 40° C. to 160° C. for ten cycles, the third temperature point indicating high electrical resistance in the over-current protection device 10 is recorded. A value by subtracting the second temperature point from the first temperature point is defined as a first fluctuation value, and a value by subtracting the third temperature point from the first temperature point is defined as a second fluctuation value. In an embodiment, the first fluctuation value of the over-current protection device 10 under high-resistance state ranges from 0.1 to 2.2. In an embodiment, the second fluctuation value of the over-current protection device 10 under high-resistance state ranges from 2 to 6.3. One of the reasons the over-current protection device 10 achieves good high-resistance stability is due to the coupling capability of the olefin-acrylate copolymer. The olefin-acrylate copolymer may act as a coupling agent, enhancing interfacial adhesion between an inorganic material (e.g., the top metal layer 12 or bottom metal layer 13) and an organic material (e.g., the heat-sensitive layer 11). The —OR group in the acrylate repeating unit is able to chemically bond to the surface of the inorganic material. In this manner, the top metal layer 12 and the bottom metal layer 13 can stably attach to the heat-sensitive layer 11, enabling the over-current protection device 10 to maintain excellent structural integrity. The over-current protection device 10 is less prone to irreversible deformation when it experiences multiple trip events. If the amount of the olefin-acrylate copolymer is appropriately increased, it can effectively enhance the stability of the high-resistance stability of the over-current protection device 10. For example, in an embodiment, the total volume of the heat-sensitive layer 11 is calculated as 100%, the polyolefin-based polymer accounts for 45% to 48% and the olefin-acrylate copolymer accounts for 7% to 12%. In an embodiment, the total weight of the polymer matrix is calculated as 100%, and the acrylate repeating unit accounts for 15% to 20%. After the aforementioned adjustment, the first fluctuation value of the over-current protection device 10 under high-resistance state ranges from 0.1 to 1, and the second fluctuation value of the over-current protection device 10 under high-resistance state ranges from 2 to 3.

Since the thermal cutting-off temperature of the over-current protection device 10 is lower than that of the conventional one, the hold current of the over-current protection device 10 will also be lower than that of the conventional one at the same temperature. The “hold current” refers to the maximum current that the over-current protection device 10 allows to flow through it without tripping. The over-current protection device 10, with its low thermal cutting-off temperature, may exhibit a relatively high electrical resistance at a low temperature, correspondingly allowing a relatively low hold current to flow therethrough. Generally, the hold current decreases as the temperature rises, a phenomenon known as the effect of thermal derating. In an embodiment, a hold-current thermal derating ratio of the over-current protection device 10 is less than 0.55, wherein the hold-current thermal derating ratio is defined as a ratio obtained by dividing a hold current of the over-current protection device 10 under 60° C. by a hold current of the over-current protection device 10 under 23° C. In another embodiment, the hold-current thermal derating ratio of the over-current protection device 10 ranges from 0.3 to 0.4. In contrast, the hold-current thermal derating ratio of the conventional over-current protection device is about 0.65, which is significantly higher than the aforementioned 0.55 of the over-current protection device 10, for example. Clearly, as the temperature rises, the over-current protection device 10 of the present invention may cut off the current flow earlier.

Moreover, the polymer matrix of the present invention can be applied to any type of low-rho over-current protection device. This means its conductive filler may consist of a metal-ceramic material, resulting in the electrical resistivity of the over-current protection device ranging from 0.01 Ω·cm to 0.065 Ω·cm, such as 0.01 Ω·cm, 0.015 Ω·cm, 0.02 Ω·cm, 0.025 Ω·cm, 0.03 Ω·cm, 0.035 Ω·cm, 0.04 Ω·cm, 0.045 Ω·cm, 0.05 Ω·cm, 0.055 Ω·cm, 0.06 Ω·cm, or 0.065 Ω·cm. The term “low-rho” refers to low electrical resistivity. The metal-ceramic material is selected from the group consisting of tungsten carbide, titanium carbide, vanadium carbide, zirconium carbide, niobium carbide, tantalum carbide, molybdenum carbide, hafnium carbide, titanium boride, vanadium boride, zirconium boride, niobium boride, molybdenum boride, hafnium boride, zirconium nitride, and any combination thereof. It is worth noting that, besides the conductive filler, the heat-sensitive layer 11 of the over-current protection device 10 does not require the addition of any functional fillers to achieve good electrical characteristics, such as the thermal cutting-off temperature, resistance stability, durability, or similar and other unexpected characteristics. The functional filler may be a conventional flame retardant selected from the group consisting of zinc oxide, antimony oxide, aluminum oxide, silicon oxide, calcium carbonate, magnesium sulfate, barium sulfate, magnesium hydroxide, aluminum hydroxide, calcium hydroxide, and barium hydroxide. The functional filler may also be a perovskite-based compound selected from the group consisting of barium titanate (BaTiO₃), strontium titanate (SrTiO₃), and calcium titanate (CaTiO₃). In an embodiment, the heat-sensitive layer 11 of the over-current protection device 10 excludes the aforementioned flame retardant and perovskite-based compound, simplifying the formulation design of the heat-sensitive layer 11. In this way, the present invention reduces the material cost and complexity of the material composition of the over-current protection device 10, facilitating the setting of various parameters in the manufacturing process.

Please refer to FIG. 2, which shows the top view of the over-current protection device 10 shown in FIG. 1. The over-current protection device 10 has a length A and a width B, and the top-view area “A×B” of the over-current protection device 10 is substantially equivalent to the top-view area of the heat-sensitive layer 11. The heat-sensitive layer 11 may have a top-view area ranging from 4 mm² to 72 mm² based on the size of different products. For example, the top-view area “A×B” may be 2×2 mm², 2.3×2.3 mm², 2.5×3 mm², 2.8×3.5 mm², 4×4 mm², 5×5 mm², 5.1×6.1 mm², 5×7 mm², 7.62×7.62 mm², 8.2×7.15 mm², 7.3×9.5 mm², or 7.62×9.35 mm². In addition, the total thickness of the over-current protection device 10 (i.e., the total thickness of the top metal layer 12, the heat-sensitive layer 11, and the bottom metal layer 13) ranges from 0.25 mm to 0.35 mm. More specifically, the thickness of each of the upper metal layer 12 and the lower metal layer 13 is 0.07 mm, and the thickness of the heat-sensitive layer 11 correspondingly ranges from 0.11 mm to 0.21 mm, such as 0.11 mm, 0.12 mm, 0.13 mm, 0.14 mm, 0.15 mm, 0.16 mm, 0.17 mm, 0.18 mm, 0.19 mm, 0.2 mm, or 0.21 mm. In a preferred embodiment, the top-view area of the over-current protection device 10 ranges from 4 mm² to 12 mm², and the thickness of the heat-sensitive layer 11 ranges from about 0.15 mm to about 0.17 mm. It is understood that the present invention can apply to any size of the over-current protection device 10 described above to achieve the same technical effect. The over-current protection device 10 can be processed into different device types commonly used in the industry, such as surface-mount device (SMD), axial-leaded device (ALD), radial-leaded device (RLD), or other device types, depending on the requirements.

In order to provide a more specific description of the technical content of the present invention, Tables 1 to 3 shown below are further discussed using actual verification data.

TABLE 1
Volume percentage (vol %) of the heat-sensitive layer.

| Group | HDPE | LDPE | Copolymer | WC |
|---|---|---|---|---|
| E1 | 0 | 55 | 0 | 45 |
| E2 | 0 | 53.35 | 1.65 | 45 |
| E3 | 0 | 50.05 | 4.95 | 45 |
| E4 | 0 | 48.40 | 6.60 | 45 |
| E5 | 0 | 46.75 | 8.25 | 45 |
| E6 | 0 | 46.20 | 8.80 | 45 |
| E7 | 0 | 44.00 | 11.00 | 45 |
| E8 | 0 | 44.00 | 11.00 | 45 |
| E9 | 0 | 44.00 | 11.00 | 45 |
| C1 | 55 | 0 | 0 | 45 |

Table 1 shows the volume percentage composition of the heat-sensitive layer in accordance with the embodiments (E1 to E9) of the present invention and the comparative example (C1). The first row in Table 1 shows various materials used for the heat-sensitive layer from left to right, that is, high density polyethylene (HDPE), low density polyethylene (LDPE), copolymer, and tungsten carbide (WC). The “copolymer” in Table 1 refers to the olefin-acrylate copolymer as previously mentioned. In the embodiments E2 to E7, the copolymer used in the heat-sensitive layer is ethylene-butyl acrylate copolymer. Given the significant improvement in device performance observed in the embodiments E2 to E7, two other types of olefin-acrylate copolymer are further tested in the embodiments E8 and E9. In the embodiment E8, the copolymer used in the heat-sensitive layer is ethylene-methyl acrylate copolymer. In the embodiment E9, the copolymer used in the heat-sensitive layer is ethylene-ethyl acrylate copolymer. Considering the measurement error and the permissible error tolerance, the volume percentage of LDPE may range from 43% to 56%, while the volume percentage of the copolymer may range from 0% to 12%. Within these ranges, the over-current protection device can achieve the same or similar technical effects. In order to enhance electrical conduction for large current flow, the conductive filler does not include carbon black. That is, the conductive filler solely consists of tungsten carbide. If the conductive filler includes carbon black, the electrical resistivity of the over-current protection device is generally higher than 0.1 Ω·cm. Moreover, the present invention doesn't need any flame retardants (e.g., magnesium hydroxide, as conventionally used) and other inner fillers to achieve the desired low protection temperature in the over-current protection device. To simplify the formulation design, the present invention not only excludes the flame retardants and other inner fillers but also exclusively uses a single material (i.e., tungsten carbide) in the conductive filler.

The manufacturing process of the over-current protection devices of the embodiments E1 to E9 and the comparative example C1 is described below. According to the composition shown in Table 1, materials are prepared and put into HAAKE twin screw blender for blending. The blending temperature is 215° C., the time for pre-mixing is 3 minutes, and the blending time is 15 minutes. The conductive polymer after being blended is pressed into a sheet by a hot press machine at a temperature of 210° C. and a pressure of 150 kg/cm². The sheet is then cut into pieces of about 20 cm×20 cm, and two nickel-plated copper foils are laminated to two sides of the sheet with the hot press machine at a temperature of 210° C. and a pressure of 150 kg/cm², by which a three-layered structure is formed. Then, the sheet with the nickel-plated copper foils is punched into PTC chips, each of which is the over-current protection device. Each sample of the over-current protection device has the length of 2.8 mm and the width of 3.5 mm (i.e., top-view area is 9.8 mm²), and the thickness thereof is 0.3 mm. Then, the PTC chips of the embodiments and comparative example are subjected to electron beam irradiation of 15 kGy (irradiation dose can be adjusted depending on the requirement). After irradiation, the following measurements are performed by taking fifteen PTC chips as samples to be tested for each group.

TABLE 2
Various electrical characteristics.

| | Rᵢ | ρ | TCO | I-H_{23° C.} | I-H_{60° C.} | |
|---|---|---|---|---|---|---|
| Group | (Ω) | (Ω · cm) | (° C.) | (A) | (A) | I-H_{60° C.}/I-H_{23° C.} |
| E1 | 0.00474 | 0.0155 | 80.7 | 5.26 | 2.7 | 0.513 |
| E2 | 0.00507 | 0.0166 | 75.56 | 4.8 | 2.6 | 0.541 |
| E3 | 0.00666 | 0.0218 | 61 | 3.7 | 1.5 | 0.396 |
| E4 | 0.00468 | 0.0153 | 64.36 | 3.6 | 1.5 | 0.420 |
| E5 | 0.00634 | 0.0207 | 55.86 | 3.3 | 1.2 | 0.356 |
| E6 | 0.01001 | 0.0327 | 47.03 | 2.7 | 0.8 | 0.306 |
| E7 | 0.01949 | 0.0637 | 41.92 | 2.5 | 0.7 | 0.264 |
| E8 | 0.01654 | 0.0540 | 50.31 | 3.4 | 1.1 | 0.346 |
| E9 | 0.01711 | 0.0559 | 49.22 | 3.0 | 0.9 | 0.306 |
| C1 | 0.00184 | 0.0011 | 121.5 | 7.8 | 5.1 | 0.654 |

“Rᵢ” refers to the initial electrical resistance of the over-current protection device at room temperature. In addition, the electrical resistance formula is ρ = R × A/L, where “R” is electrical resistance, “L” is length (thickness), and “A” is cross sectional area. Accordingly, the electrical resistivity ρᵢ can be calculated based on Rᵢ.

“TCO” refers to the thermal cutting-off temperature, and its measurement method is described as follows. The over-current protection device is placed in an oven and electrically connected to an external power source (at 12V/1.6A). The temperature inside the oven gradually increases from room temperature at a rate of 1° C. per minute. When the temperature inside the oven reaches a specific level, the over-current protection device will no longer conduct the external power source. This specific temperature is identified as the thermal cutting-off temperature of the over-current protection device.

“I-H_{23° C.}” and “I-H_{60° C.}” refer to the hold currents of the over-current protection device at 23° C. and 60° C., respectively. The over-current protection device is placed in the oven set to 23° C., and the maximum current it can withstand without tripping is measured, thus obtaining I-H_{23° C.}. The over-current protection device is placed in the oven set to 60° C., and the maximum current it can withstand without tripping is measured, thus obtaining I-H_{60° C.}. “I-H_{60° C.}/I-H_{23° C.}” represents the hold-current thermal derating ratio, as previously defined.

According to Table 2, in the embodiments E1 to E9, the electrical resistivity ranges from 0.0155 Ω·cm to 0.0637 Ω·cm. Although this range is higher than the electrical resistivity of the comparative example C1 (i.e., 0.0011 Ω·cm), it represents a significant reduction compared to conventional over-current protection devices that use carbon black as the conductive filler (not shown). Therefore, the present invention, exemplified by the embodiments E1 to E9, is suitable for manufacturing low-rho over-current protection devices, fulfilling the requirements of electronic apparatuses with specific rated current demands. As for the thermal cutting-off temperature, all the embodiments E1 to E9 of the present invention maintain it below 85° C., which meets the requirement for overheating protection at lower temperatures. In contrast, the thermal cutting-off temperature of the comparative example C1 reaches up to 121.5° C., causing a delay in cutting off the current flow of the over-current protection device and leading to damage or destruction of the electronic apparatus to be protected.

It is understood that over-current protection devices with low thermal cutting-off temperatures (such as the embodiments E1 to E9) exhibit higher electrical resistance values at lower temperatures, thereby enabling them to cut off the flow of current at these lower temperatures. Consequently, it can be inferred that at a specific temperature, the over-current protection devices with low thermal cutoff temperatures will have lower hold currents. As the temperature increases, they also exhibit lower hold-current thermal derating ratios. In the embodiments E1 to E9, the hold-current thermal derating ratio (I-H_{60° C.}/I-H_{23° C.}) ranges from 0.264 to 0.541. In contrast, the hold-current thermal derating ratio (I-H_{60° C.}/I-H_{23° C.}) of the comparative example C1 is 0.654, which is significantly higher than values within the aforementioned range of the embodiments E1 to E9. Clearly, the embodiments E1 to E9 of the present invention demonstrate a pronounced phenomenon in thermal derating, thereby cutting off the current flow earlier.

TABLE 3
Resistance-temperature test.

| | T₁ | T₅ | T₁₀ | T₁ − T₅ | T₁ − T₁₀ | Acrylate content |
|---|---|---|---|---|---|---|
| Group | (° C.) | (° C.) | (° C.) | (° C.) | (° C.) | (wt %) |
| E1 | 105.3 | 103.9 | 102.8 | 1.4 | 2.5 | 0 |
| E2 | 103.1 | 101.2 | 99.8 | 1.9 | 3.3 | 3 |
| E3 | 91.2 | 89.6 | 87.5 | 1.6 | 3.7 | 9 |
| E4 | 91.4 | 89.8 | 85.7 | 1.6 | 5.7 | 12 |
| E5 | 87.9 | 87.1 | 85.8 | 0.8 | 2.1 | 15 |
| E6 | 85.3 | 83.3 | 79.9 | 2 | 5.4 | 16 |
| E7 | 83.1 | 81 | 76.9 | 2.1 | 6.2 | 20 |
| E8 | 88.3 | 88.1 | 86.1 | 0.2 | 2.2 | 20 |
| E9 | 86.6 | 85.7 | 83.9 | 0.9 | 2.7 | 20 |

It should be noted that the thermal cutting-off temperature of the comparative example C1 is significantly higher and fails to meet the requirements for applications needing low-temperature overheating protection. Therefore, there is no necessity to perform further tests on the comparative example C1, and no data of it is shown in Table 3. In the resistance-temperature test, the over-current protection device is placed in an oven, and the electrical resistance as a function of temperature can be measured. In the oven, the temperature increases from 40° C. to 160° C. at a rate of 5° C./min. This thermal treatment may involve multiple cycles as described above, and the changes in the temperature required to reach a resistance of 10⁵Ω can be recorded. “T₁” refers to the temperature (i.e., the first temperature point) at which the electrical resistance rises to 10⁵Ω in the first cycle of thermal treatment. “T₅” refers to the temperature (i.e., the second temperature point) at which the electrical resistance rises to 10⁵Ω in the fifth cycle of thermal treatment. “T₁₀” refers to the temperature (i.e., the third temperature point) at which the electrical resistance rises to 10⁵Ω in the tenth cycle of thermal treatment. The difference between T₁ and T₅ (T₁-T₅) is the first fluctuation value as previously defined. The difference between T₁ and T₁₀ (T₁−T₁₀) is the second fluctuation value as previously defined. The lower the first fluctuation value or the second fluctuation value, the better the high-resistance stability. In addition, Table 3 also shows the weight percentage of the acrylate repeating unit, referred to as acrylate content, in the polymer matrix (i.e., LDPE and copolymer).

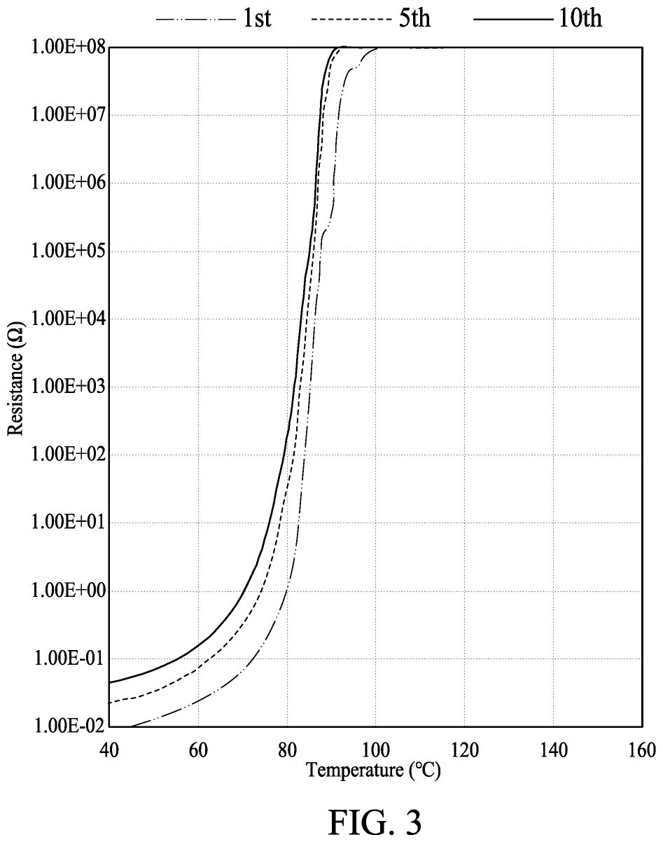

In the embodiments E2 to E7, the copolymer used in the heat-sensitive layer is ethylene-butyl acrylate copolymer. As the acrylate content increases from 0% to 20%, T₁−T₅ and T₁−T₁₀ generally demonstrate an upward trend, except for embodiment E5, which shows a significant decline in both T₁-T₅ and T₁-T₁₀. Based on the above, adjusting the acrylate content of ethylene-butyl acrylate copolymer to 15% enables the over-current protection device to achieve the best high-resistance stability. As shown in FIG. 3, curves labeled 1st, 5th, and 10th depict the results of the first, fifth, and tenth cycles of thermal treatment, respectively, in the embodiment E5. Regarding the curve 1st, the temperature at which the electrical resistance reaches 10⁵Ω is 87.9° C. Regarding the curve 5th, the temperature at which the electrical resistance reaches 10⁵Ω is 87.1° C. Regarding the curve 10th, the temperature at which the electrical resistance reaches 10⁵Ω is 85.8° C. Moreover, the high-resistance stability can also be enhanced by using other types of olefin-acrylate copolymer. In the embodiments E8 and E9, the copolymers used in the heat-sensitive layer are ethylene-methyl acrylate copolymer and ethylene-ethyl acrylate copolymer, respectively. As the acrylate content in the embodiments E8 and E9 is increased to 20%, T₁-T₅ ranges from 0.2 to 0.9 and T₁-T₁₀ ranges from 2.2 to 2.7, both of which are similar to the values of T₁-T₅ and T₁-T₁₀ in the embodiment E5. Based on the above, adjusting the acrylate content to at least 15% enables the over-current protection device to achieve the best high-resistance stability.

The above-described embodiments of the present invention are intended to be illustrative only. Numerous alternative embodiments may be devised by persons skilled in the art without departing from the scope of the following claims.

What is claimed is:

1. An over-current protection device, comprising:
an electrode layer having a top metal layer and a bottom metal layer; and
in a heat-sensitive layer contacting the top metal layer and the bottom metal layer, and being laminated therebetween, wherein the heat-sensitive layer exhibits a positive temperature coefficient (PTC) characteristic and comprises:
a polymer matrix comprising a polyolefin-based polymer and an olefin-acrylate copolymer, wherein the total volume of the heat-sensitive layer is calculated as 100%, and the olefin-acrylate copolymer accounts for less than 12%, wherein:
the polyolefin-based polymer is represented by a formula (I): 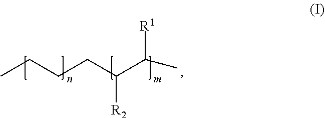
wherein R₁ and R₂ are selected from the group consisting of CH₃, C₂H₅, and C₃H₇, m ranges from 3000 to 8000, and n ranges from 1000 to 3000; and
the olefin-acrylate copolymer is represented by a formula (II): 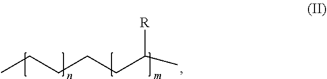
wherein R is selected from the group consisting of COOCH₃, COOC₂H₅, and COOC₄H₉, m ranges from 800 to 5000, and n ranges from 500 to 1000; and
a conductive filler dispersed in the polymer matrix, thereby forming an electrically conductive path in the heat-sensitive layer.

2. The over-current protection device of claim 1, wherein the total volume of the heat-sensitive layer is calculated as 100%, the polyolefin-based polymer accounts for 43% to 56%.

3. The over-current protection device of claim 2, wherein the total volume of the heat-sensitive layer is calculated as 100%, the polyolefin-based polymer accounts for 45% to 48% and the olefin-acrylate copolymer accounts for 7% to 12%.

4. The over-current protection device of claim 1, wherein the olefin-acrylate copolymer has an acrylate repeating unit represented by a formula (III): 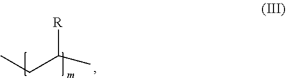
wherein the total weight of the polymer matrix is calculated as 100%, and the acrylate repeating unit accounts for less than 20%.

5. The over-current protection device of claim 4, wherein the total weight of the polymer matrix is calculated as 100%, and the acrylate repeating unit accounts for 15% to 20%.

6. The over-current protection device of claim 1, wherein a thermal cutting-off temperature of the over-current protection device ranges from 40° C. to 81° C.

7. The over-current protection device of claim 1, wherein a hold-current thermal derating ratio of the over-current protection device is less than 0.55, wherein the hold-current thermal derating ratio is defined as a ratio obtained by dividing a hold current of the over-current protection device under 60° C. by a hold current of the over-current protection device under 23° C.

8. The over-current protection device of claim 1, wherein a first fluctuation value of the over-current protection device under high-resistance state ranges from 0.1 to 2.2, wherein:
after a thermal treatment from 40° C. to 160° C. for one cycle, a first temperature point indicating high electrical resistance in the over-current protection device is obtained;
after the thermal treatment from 40° C. to 160° C. for five cycles, a second temperature point indicating high electrical resistance in the over-current protection device is obtained; and
the first fluctuation value is obtained by subtracting the second temperature point from the first temperature point.

9. The over-current protection device of claim 8, wherein the first fluctuation value ranges from 0.1 to 1.

10. The over-current protection device of claim 1, wherein a second fluctuation value of the over-current protection device under high-resistance state ranges from 2 to 6.3, wherein:
after a thermal treatment from 40° C. to 160° C. for one cycle, a first temperature point indicating high electrical resistance in the over-current protection device is obtained;
after the thermal treatment from 40° C. to 160° C. for ten cycles, a third temperature point indicating high electrical resistance in the over-current protection device is obtained; and
the second fluctuation value is obtained by subtracting the third temperature point from the first temperature point.

11. The over-current protection device of claim 10, wherein the second fluctuation value ranges from 2 to 3.

12. The over-current protection device of claim 1, wherein an electrical resistivity of the over-current protection device ranges from 0.01 Ω·cm to 0.065 Ω·cm.
